(19) United States
(12) Patent Application Publication
(10) Pub. No.: US 2016/0119748 A1
(43) Pub. Date: Apr. 28, 2016

(54) PUSHING INFORMATION

(71) Applicant: Alibaba Group Holding Limited, Grand Cayman (KY)

(72) Inventors: Xiabo Li, Hangzhou (CN); Bing Sun, Hangzhou (CN)

(21) Appl. No.: 14/920,220

(22) Filed: Oct. 22, 2015

(30) Foreign Application Priority Data
Oct. 27, 2014 (CN) 201410585037.5

(51) Int. Cl. H04W 4/02; H04L 29/08

(52) U.S. Cl. CPC H04W 4/021; H04L 67/26

(57) ABSTRACT

An example method for pushing information includes obtaining a code value that represents a current geographic location area of a terminal corresponding to a client; obtaining a geo-fence list corresponding to the code value based on the code value and a pre-established inverted index table of one or more geo-fences; processing the one or more geo-fences in the geo-fence list based on a preset condition; and pushing corresponding information to the client based on a result of the processing. The techniques of the present disclosure convert real-time computation of a geo-fence corresponding to the current geographic location into a querying operation, thereby reducing an amount of computation and enhancing a response speed to users.

### CROSS REFERENCE TO RELATED PATENT APPLICATION

This application claims foreign priority to Chinese Patent Application No. 201410585037.5 filed on 27 Oct. 2014, entitled “Method and Apparatus for Pushing Information”, which is hereby incorporated by reference in its entirety.

### TECHNICAL FIELD

The present disclosure relates to the field of mobile internet technology, and, more particularly, to a method and an apparatus for pushing information.

### BACKGROUND

With the rapid progress of mobile Internet technology, mobile terminals (e.g., cell phones, pads, and so on) have become more prevalent, and have provided more and more functions. Generally, users obtain their own geographic locations and their peripheral location based service (LBS) information by using applications on the mobile terminals.

Currently, when a user intends to obtain LBS services, the geo-fencing technology is used to calculate a corresponding relation between the user's geographic locations and a certain fence independently set by an LBS service provider in real time. If the geo-fence is circular in shape, a distance from a circle center to the user's geographic location is calculated, and then whether the user is in the scope of the geo-fence is determined based on a relation between a radius of the geo-fence and the distance from the circle center to the user's geographic location. If the geo-fence is a polygon in shape, whether the user is in the scope of the geo-fence is determined by using a radial method.

However, when the user is located within a lot of geo-fence scopes, a real-time calculation of a relation between the user and each geo-fence causes a great amount of computation and severely reduces the speed of obtaining a response.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure is directed to solving the technical problems in conventional techniques. Therefore, the present disclosure provides a method for pushing information, which converts a real-time computation into a querying operation, reduces an amount of computation, and enhances a response speed to users. The resent disclosure also provides an apparatus for pushing information.

The present disclosure provides an example method for pushing information, which may include the following operations: obtaining a current geographic location area of a terminal corresponding to a client, such as obtaining a code value that is used for representing a current geographic location area of a client terminal and is encoded based on a preset algorithm; obtaining a map area corresponding to the current geographic location based on a pre-established relationship between map areas and geographic locations, such as obtaining a geo-fence list corresponding to the code value, based on the code value and a pre-established inverted index table of geo-fences; and pushing information relating to the map area to the client, such as processing the geo-fences in the geo-fence list based on a preset condition, and pushing corresponding information to the client terminal based on a processed result.

In the example method for pushing information according to an example embodiment of the present disclosure, the techniques of the present disclosure obtain a code value that is used for representing a current geographic location area of a client terminal and is encoded based on a preset algorithm, obtain a geo-fence list corresponding to the code value based on the code value and a pre-established inverted index table of the geo-fences, and push information corresponding to geo-fence to the client terminal, which convert a real-time computation into a querying operation, reduce the amount of computation, and enhance a response speed to users.

The present disclosure also provides an example apparatus for pushing information, which may include: a first obtaining module that obtains a code value that is used for representing a current geographic location area of a client terminal and is encoded based on a preset algorithm; a second obtaining module that obtains a geo-fence list corresponding to the code value, based on the code value and a pre-established inverted index table of geo-fences; and a processing module that processes geo-fences in the geo-fence list based on a preset condition, and pushes corresponding information to a client terminal based on a processed result.

In an apparatus for pushing information according to an example embodiment of the present disclosure, the techniques of the present disclosure obtain a code value that is used for representing a current geographic location area of a client terminal and that is encoded based on a preset algorithm, obtain a geo-fence list corresponding to the code value based on the code value and a pre-established inverted index table of geo-fences, and push information corresponding to geo-fence to the client terminal. The techniques of the present disclosure convert real-time computation into a querying operation, reduce the amount of computation, and enhance a response speed to users.

The additional aspects and advantages of the present disclosure are described in the following detailed descriptions, and some of the aspects and advantages may become apparent based on the following descriptions or by implementing the present disclosure.

### BRIEF DESCRIPTION OF THE DRAWINGS

FIG. 1 is a flow chart of an example method for pushing information according to an example embodiment of the present disclosure.

FIG. 2 is a flow chart of an example method for pushing information according to a specific implementation of the present disclosure.

FIG. 3 is a schematic structural diagram of an example apparatus for pushing information according to an example embodiment of the present disclosure.

### DETAILED DESCRIPTION

The example embodiments of the present disclosure are described below in great detail, and examples in the example embodiments are illustrated in the accompanying drawings, in which the same or similar reference numerals through all the drawings are used to represent the same or similar elements or elements having the same or similar functions. The example embodiments described with reference to the accompanying drawings are only demonstrative, which are intended to illustrate the present disclosure, instead of restricting the present disclosure.

The method and apparatus for pushing information according to the example embodiments of the present disclosure are described below with reference to the accompanying drawings.

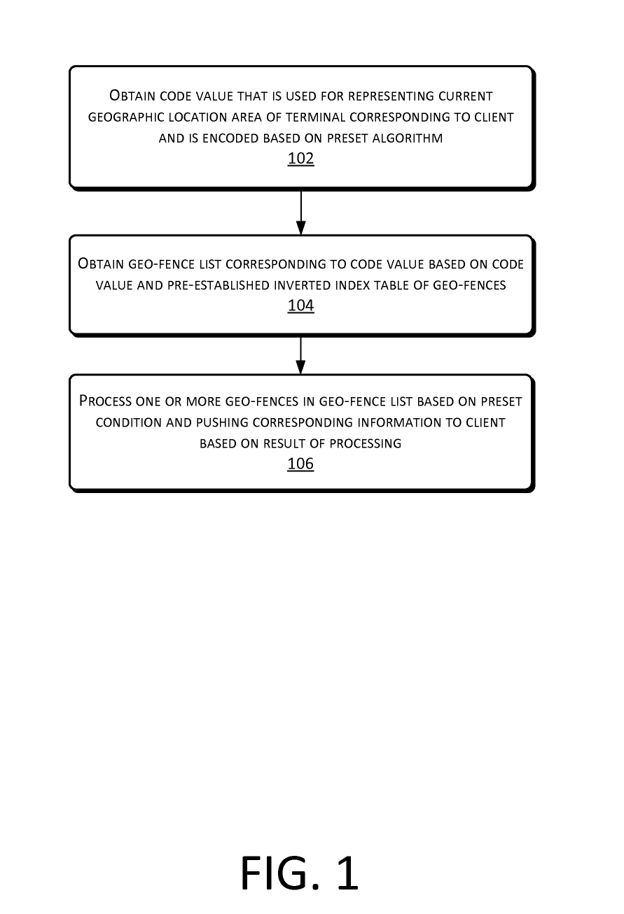

FIG. 1 is a flow chart of an example method for pushing information according to an example embodiment of the present disclosure.

Referring to FIG. 1, the example method for pushing information may include the following steps:

At 102, a code value, which is used for representing a current geographic location area of a terminal corresponding to a client and is encoded based on a preset algorithm, is obtained.

For example, a client is an application (APP) executed on a terminal of a user. The terminal may be a cell phone, a pad, a portable personal computer, a personal digital assistant (PDA), and so on.

For example, the geographic location area may be encoded based on a geohash algorithm. The geohash is a method of representing a geographic location block by using character strings. For instance, when a length of the character string is 8 bytes, a certain geographic area may be represented by a plurality of geohash blocks with a size of 38 meter*19 meter, in which each geohash block corresponds to a unique character string.

For example, a current geographic location area of a corresponding terminal uploaded by the client is received, and the received geographic location area is converted into a corresponding code value based on a preset algorithm. Alternatively, a code value converted from the geographic location area of the corresponding terminal based on a preset algorithm, uploaded by the client, is received. The preset algorithm may be a geohash algorithm.

At 104, a geo-fence list corresponding to the code value is obtained based on the code value and a pre-established inverted index table of geo-fences.

In an example embodiment of the present disclosure, the inverted index table of geo-fences for LBS services is pre-established.

For example, the techniques of the present disclosure receive a map-fence set by a user or a merchant, obtain projected coordinates of the map-fence, convert the projected coordinates into geographic coordinates, and obtain geographic location areas contained by corresponding geo-fences based on the geographic coordinates. The techniques further combine the geographic location areas, and establish the inverted index table based on the combined geographic location areas. The inverted index table contains corresponding relations between a code value corresponding to each geographic location area encoded based on a preset algorithm (e.g., a code value converted based on a geohash algorithm) and geo-fences set for the corresponding geographic location area. Assuming that a code value corresponding to a particular geographic location area is Uw2xv3pt, and the geo-fence 1, geo-fence 2, geo-fence3, and geo-fence 4 all contain the geographic location area, the inverted index table contains corresponding relations between Uw2xv3pt and geo-fence 1, geo-fence 2, geo-fence 3, and geo-fence 4.

Thus, after obtaining the code value that is used for representing the current geographic location area of the terminal corresponding to the client, the techniques of the present disclosure may query the inverted index table based on the code value, and obtain the geo-fence list corresponding to the geographic location area represented by the code value.

At 106, one or more geo-fences in the geo-fence list are processed based on a preset condition, and corresponding information is pushed to the client based on a result of the processing.

For example, the techniques of the present disclosure sort the geo-fences in the geo-fence list based on a preset condition, and push information about a corresponding merchant to the client based on a sorting result. For example, assuming that the geo-fence is circular in shape, and the preset condition is a distance from the terminal to the circle center of the geo-fence, the geo-fences in the geo-fence list are sorted based on the distance from large to small, and then the information about a corresponding merchant is pushed to the terminal of the client based on the sorting result.

Certainly, the techniques of the present disclosure may filter the geo-fences in the geo-fence list based on a preset condition, and push information about a corresponding merchant to the terminal of the client based on a filtering result. The preset condition may be a preference of the user who uses the client, such as the user' favorite clothes, and then, based on the preset condition, filter the geo-fences in the geo-fence list and push information of a corresponding clothes merchant to the client.

In the example method for pushing information according to the example embodiment of the present disclosure, the techniques of the present disclosure, by obtaining a code value that is used for representing a current geographic location area of a terminal corresponding to a client and is encoded based on a preset algorithm, obtain a geo-fence list corresponding to the code value based on the code value and a pre-established inverted index table of geo-fences, and push information corresponding to geo-fence to the client, convert a real-time computation into a querying operation, reduce the amount of computation, and enhances a response speed to users.

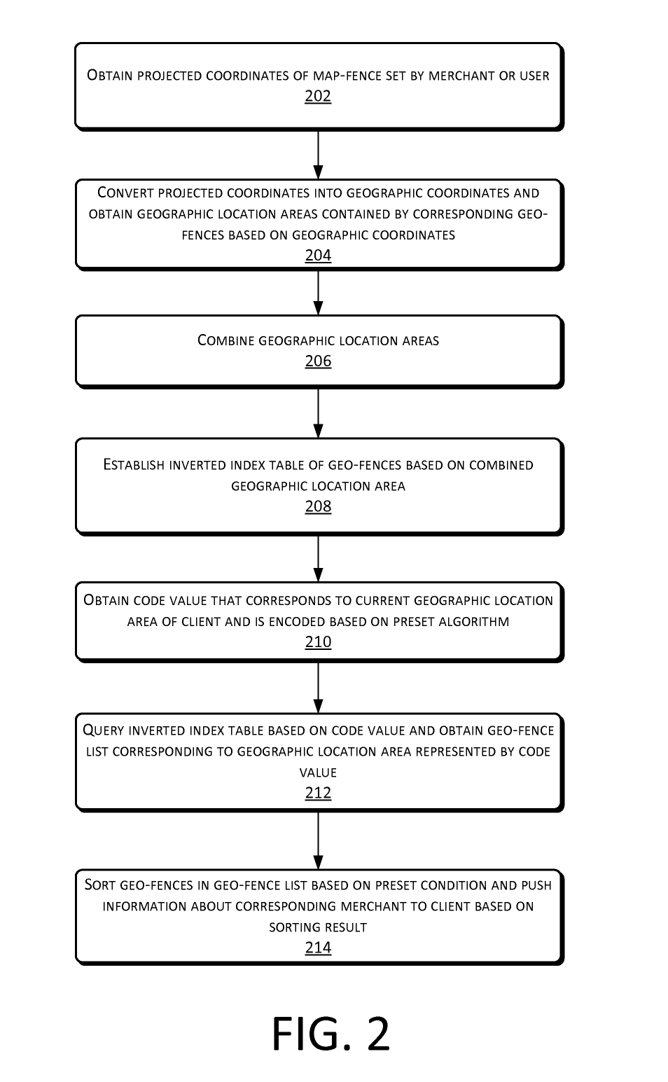

FIG. 2 is a flow chart of a method for pushing information according to an example implementation of the present disclosure.

Referring to FIG. 2, the method for pushing information includes the following steps:

At 202, projected coordinates of a map-fence set by a merchant or a user are obtained.

For example, the merchant or the user may set a shape of the map-fence. If the map-fence is circular in shape, a projected coordinates of a circle center and a radius of the map-fence are obtained. If the map-fence is a polygon in shape, projected coordinates of each vertex of the map-fence are obtained.

At 204, the projected coordinates are converted into geographic coordinates, and geographic location areas contained by corresponding geo-fences are obtained based on the geographic coordinates.

If the map-fence is polygonal in shape, the projected coordinate of each vertex of the map-fence is converted into a geographic coordinate. If the map-fence is circular in shape, the circle is represented by a polygon with 360 edges, and then the projected coordinates of the 360 vertexes are converted into geographic coordinates.

For example, using a circle as an example, with given coordinates of the circle center (represented by longitude and latitude) and a radius, a calculation formula to calculate geographic coordinates of vertex of the circle is as follows: the coordinates of vertex=coordinate of the circle center+changed longitude and changed latitude. In the above equation, the changed latitude=((radius/earth radius)/(pi/180), and the changed longitude=changed latitude/cos(latitude of the circle center*pi/189), in which pi is a (π) ratio of the circumference.

After the projected coordinates are converted into the geographic coordinates, a geographic location area contained by corresponding geo-fences is obtained based on the geographic coordinates. For example, the techniques of the present disclosure obtain four values from the geographic coordinates of the polygon, that is, the largest longitude, the smallest longitude, the largest latitude, and the smallest latitude. Based on the above four values, a smallest rectangle that covers the geo-fence is obtained, and a conversion of the rectangle into 8-byte-long geohash blocks (that is, geographic location area) is completed to obtain a collection D. Then, the collection D is divided by a radial method into three parts including a geo-fence inner collection I, a geo-fence edge collection E, and a geo-fence outer collection O. Then, an overlapped area between the collection E and the geohash blocks is calculated, and if the overlapped area is larger than one half of an area of a standard geohash block, the geohash block is put into the collection I.

At 206, the geographic location areas are combined.

For example, small geohash blocks are combined into a large geohash block. For instance, 32 adjacent small geohash blocks may be combined into a large geohash block, thereby effectively reducing a quantity of geohash blocks in the collection I.

At 208, an inverted index table of geo-fences is established based on the combined geographic location area.

Assuming that a code value corresponding to a certain geographic location area is Uw2xv3pt, and geo-fence 1, geo-fence 2, geo-fence 3, and geo-fence 4 all contain the geographic location area, the inverted index table contains corresponding relations between Uw2xv3pt and geo-fence 1, geo-fence 2, geo-fence 3, and geo-fence 4.

For example, operations from 202 to 208 are offline operations so that the inverted index table is pre-established through 202 to 208, to save the time spent on online computation. Thus, the client obtains a response faster, that is, quickly obtains information about a merchant corresponding to the current geographic location area.

At 210, a code value, which corresponds to a current geographic location area of the terminal of the client and is encoded based on a preset algorithm, is obtained.

For example, the geographic location area may be encoded based on a geohash algorithm. The geohash is a method of representing a geographic location block by using character strings. For instance, when a length of the character string is 8 bytes, a particular geographic area may be represented by a plurality of geohash blocks with a size of 38 meter*19 meter, in which each geohash block corresponds to a unique character string.

For example, the techniques of the present disclosure may obtain a global positioning system (GPS) value of a current geographic location area of the terminal of the client, and then convert the GPS value into a corresponding geohash code value based on a geohash algorithm such as Uw2xv3pt.

At 212, the inverted index table is queried based on the code value, and a geo-fence list corresponding to the geographic location area represented by the code value is obtained.

At 214, the geo-fences in the geo-fence list are sorted based on a preset condition, and information about a corresponding merchant is pushed to the client based on a sorting result.

For example, the techniques of the present disclosure sort geo-fences in the geo-fence list based on a preset condition, and push information about a corresponding merchant to the client based on a sorting result. For instance, assuming that the geo-fence is a circle in shape, the preset condition is a distance from the terminal corresponding to the client to the circle center of the geo-fence, the geo-fences in the geo-fence list are sorted based on the distance from large to small, and then the information about a corresponding merchant is pushed to the client based on the sorting result.

In the example method for pushing information according to an example embodiment of the present disclosure, the techniques of the present disclosure, by using a pre-established inverted index table, calculate corresponding relations between the geographic location area and geo-fences in advance. When a user reaches a certain geographic location area and needs to find the adjacent merchant through the client, the techniques of the present disclosure convert real-time computation into a querying operation, and thus reduce the amount of computation and enhance a response speed to the user.

The present disclosure further provides an example apparatus for pushing information.

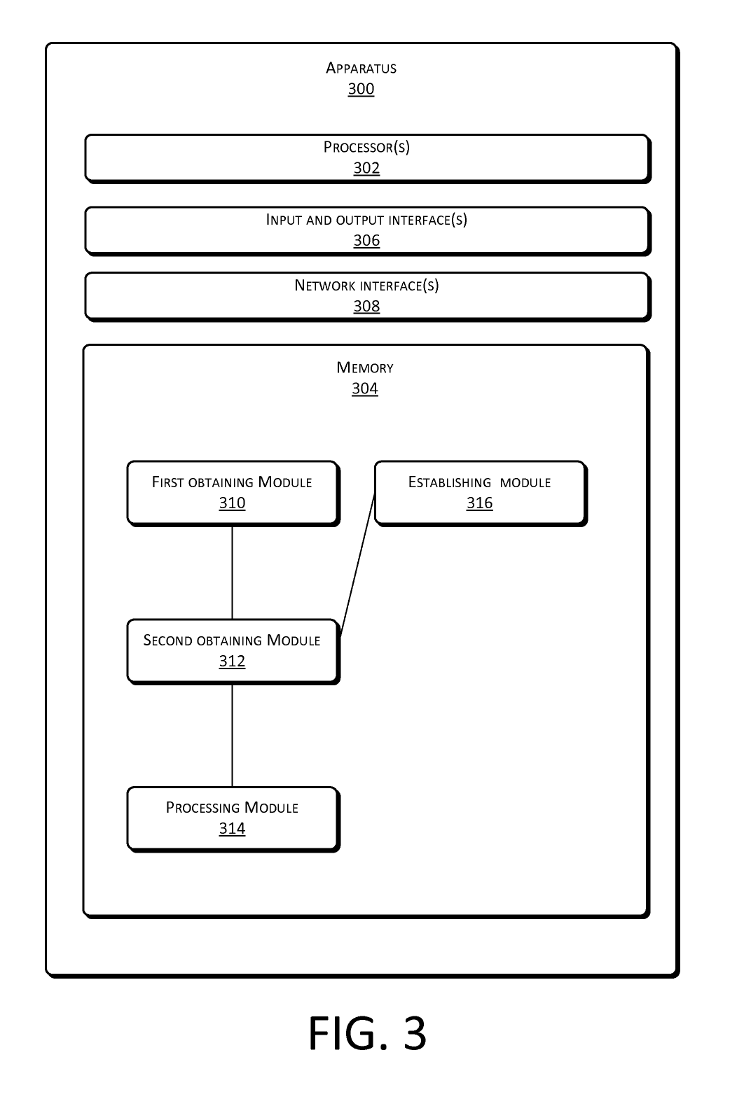

FIG. 3 is a schematic structural diagram of an example apparatus for pushing information according to an example embodiment of the present disclosure.

Referring to FIG. 3, the apparatus 300 for pushing information may include one or more processor(s) 302 or data processing unit(s) and memory 304. The device 300 may further include one or more input/output interface(s) 306, and network interface(s) 308. The memory 304 is an example of computer-readable media.

The memory 304 may store therein a plurality of modules or units including a first obtaining module 310, a second obtaining module 312, and a processing module 314.

The first obtaining module 310 obtaining a code value that is used for representing a current geographic location area of a terminal corresponding to a client and is encoded based on a preset algorithm.

For example, a client is an application (APP) executed on a terminal of a user. The terminal may be a cell phone, a pad, a portable personal computer, a personal digital assistant (PDA), and so on.

For example, the geographic location area may be encoded based on a geohash algorithm. The geohash is a method of representing a geographic location block by using character strings. For instance, when a length of the character string is 8 bytes, a certain geographic area may be represented by a plurality of geohash blocks with a size of 38 meter*19 meter, in which each geohash block corresponds to a unique character string.

For example, a current geographic location area of a corresponding terminal uploaded by the client is received, and the received geographic location area is converted into a corresponding code value based on a preset algorithm. Alternatively, a code value converted from the geographic location area of the corresponding terminal based on a preset algorithm, uploaded by the client, is received. The preset algorithm may be a geohash algorithm.

The second obtaining module 312 obtains a geo-fence list corresponding to the code value, based on the code value and a pre-established inverted index table of geo-fences.

For example, after the first obtaining module 310 obtains the code value that is used for representing a current geographic location area of a terminal corresponding to a client and is encoded based on a preset algorithm, the second obtaining module 312 queries the inverted index table based on the code value and obtains the geo-fence list corresponding to the code value.

The processing module 314 processes geo-fences in the geo-fence list based on a preset condition, and pushes corresponding information to the client based on a processed result.

For example, the processing module 314 sorts geo-fences in the geo-fence list based on a preset condition, and pushes information about a corresponding merchant to the client based on a sorting result. For instance, assuming that the geo-fence is a circle in shape, the preset condition is a distance from the client to the circle center of the geo-fence, the geo-fences in the geo-fence list are sorted based on the distance from large to small, and then the information about a corresponding merchant is pushed to the client based on the sorting result.

Certainly, the processing module 314 may filter the geo-fences in the geo-fence list based on a preset condition, and push information about a corresponding merchant to the client based on a filtering result. The preset condition may be a preference of the user who uses the client, such as the user' favorite clothes, and then, based on the preset condition, the processing module 314 filters the geo-fences in the geo-fence list, and pushes information about a corresponding clothes seller to the client.

In addition, the apparatus 300 for pushing information may further include an establishing module 316 stored on memory 304.

Before the second obtaining module 312 obtains a geo-fence list corresponding to the code value, the establishing module 316 receives a map-fence set by a user or a merchant and obtains projected coordinates of the map-fence, converts the projected coordinates into geographic coordinates, obtains a geographic location area contained by corresponding geo-fences based on the geographic coordinates, and establishes the inverted index table based on the geographic location area contained by the corresponding geo-fences.

The inverted index table contains corresponding relations between a code value corresponding to each geographic location area and one or more geo-fences set for the corresponding geographic location area. Assuming that a code value corresponding to a certain geographic location area is Uw2xv3pt, and geo-fence 1, geo-fence 2, geo-fence 3, and geo-fence 4 all contain the geographic location area, the inverted index table contains corresponding relations between Uw2xv3pt and geo-fence 1, geo-fence 2, geo-fence 3, and geo-fence 4.

In the example apparatus for pushing information according to the example embodiment of the present disclosure, the techniques of the present disclosure, by obtaining a code value that is used for representing a current geographic location area of a terminal corresponding to a client and is encoded based on a preset algorithm, obtains a geo-fence list corresponding to the code value based on the code value and a pre-established inverted index table of geo-fences, and pushes information corresponding to geo-fence to the client. Thus, the techniques of the present disclosure convert real-time computation into a querying operation, reduce the amount of computation, and enhance a response speed to users.

In the descriptions of the specifications of the present disclosure, the descriptions of the reference terms such as “an example embodiment”, “some example embodiments”, “an example”, “a detailed example”, or “some examples”, and so on means combining detailed features, structure, materials, or characteristics as described in the embodiment or example and including them into at least one embodiment or example of the present disclosure. In the specifications of the present disclosure, the illustrative expressions on the above terms are not necessarily directed to the same embodiment or example. In addition, the described detailed features, structures, materials, or characteristics may be combined in any one or a plurality of embodiments or examples in a proper way. In addition, under a precondition that the features are not contradictory, one of ordinary skill in the art may integrate and combine different embodiments or examples and features of different embodiments or examples described in the specifications.

In addition, the terms “first” and “second” are merely intended to describe the objects, instead of indicating or implying a relative importance or implying a quantity of the technical features indicated herein. Thus, the features restricted by “first” and “second” may indicate or imply that at least one of the features is included. In the descriptions of the present disclosure, the term “a plurality of” means at least two, three, and so on, unless it is specifically restricted.

For example, any description about a process or a method in a flow chart or in another manner herein may be understood as representing modules, fragments, or parts that include one or more computer-executable instructions for implementing a specific logic function or a processing step. In addition, the scope of the example embodiments of the present disclosure may cover other implementation ways, and the operations in the example embodiments may be executed substantially simultaneously or in a reversed sequence based on the involved functions without following the sequence that are discussed herein, which shall be understood by one of ordinary skill in the art.

The logic and/or operations represented in the flow chart or described herein in another manner, for example, may be considered as an ordered list of computer-executable instructions for executing logic functions, and may be implemented in any computer readable medium to be executed by an instruction executing system, apparatus, or equipment (for example, a computer-based system, a system including a processor, or a system that reads the computer-executable instructions from the instruction executing system, apparatus, or equipment and executes the instruction), or be used by integrating with the instruction executing system, apparatus, or equipment.

In terms of the specifications, the “computer readable medium” or “computer-readable media” may be any device that contain, store, communicate, transmit, or transfer computer-executable instructions to be used by the instruction executing system, apparatus, or equipment or to be integrated with the instruction executing system, apparatus, or equipment. The specific examples (a non-exhaustive list) of the computer readable medium include: an electrical connecting component (electronic device) having one or more wirings, portable computer disc chassis (magnetic device), Random Access Memory (RAM), Read Only Memory (ROM), Erasable Programmable Read Only Memory (EPROM or flash memory), an optical fiber device, and a portable CD-Read Only Memory (CDROM). In addition, the computer readable medium may be even paper or another media that the computer-executable instructions are printed thereon. For example, the paper or another proper medium may be scanned optically, and then processed by editing, parsing, or another manner if necessary, to finally obtain the computer-executable instructions in an electronic form, and then store the computer-executable instructions into a computer storage. As defined herein, the computer-readable media or computer-readable medium does not include transitory media such as a modulated data signal and a carrier wave

It shall be understood that each part of the present disclosure may be implemented by hardware, software, firmware, or a combination thereof. In the above example embodiments, a plurality of operations or methods may be implemented by software or firmware being stored in the computer-readable media and executable by a proper instruction executing system. For example, if implemented by hardware, any one of the following techniques commonly known in this field or a combination thereof may be used for implementation, which include discrete logic circuit having a logic gate circuit for performing logic functions on digital signals, an application specific integrated circuit having a proper combinational logic gate circuit, a programmable gate array (PGA), a Field Programmable Gate Array (FPGA), and so on.

One of ordinary skill in the art may understand that all or a portion of operations for implementing the above example embodiments may be executed by using computer-executable instructions to instruct relevant hardware, and the computer-executable instruction may be stored in computer readable media. When the computer-executable instructions are executed, the operations of an example method embodiment or a combination of method embodiments are executed.

In addition, in each example embodiment of the present disclosure, each of the functional units may be integrated into one processing module, or each of them may be disposed independently from one another, or two or more of the units may be integrated into one module. The above integrated modules may be implemented by hardware or software functional module. If the integrated module is implemented by software functional module and is sold or used as an independent product, it may be stored in computer-readable medium.

The above mentioned storage media may be a Real Only Memory, a magnetic disc, or an optical disc and so on. The above described example embodiments are illustrative and shall not be understood as restrictive of the present disclosure. One of ordinary skill in the art may make any change, modification, replacement, and transformation of the present disclosure within the scope of the present disclosure, which shall still fall into the protection scope of the present disclosure.

What is claimed is:

1. A method comprising:
obtaining a current geographic location area of a terminal corresponding to a client;
obtaining a map area corresponding to the current geographic location based on a pre-established relationship between map areas and geographic locations; and
pushing information relating to the map area to the client.

2. The method of claim 1, wherein the obtaining the current geographic location area of the terminal corresponding to the client includes obtaining a code value representing the current geographic location area.

3. The method of claim 2, wherein the code value is encoded based on a preset algorithm.

4. The method of claim 3, wherein the step of obtaining the code value representing the current geographic location area includes:
receiving the current geographic location area uploaded by the client; and
converting the received geographic location area into the code value based on the preset algorithm.

5. The method of claim 3, wherein the step of obtaining the code value representing the current geographic location area includes:
receiving the code value from the client and converted from the current geographic location area of the corresponding terminal based on the preset algorithm.

6. The method of claim 2, wherein the obtaining the map area corresponding to the current geographic location based on the pre-established relationship between map areas and geographic locations includes obtaining a geo-fence list corresponding to the code value based on the code value and a pre-established inverted index table of geo-fences.

7. The method of claim 2, further comprising establishing the pres-established index table of geo-fences, the establishing including:
receiving a map-fence set by a user or a merchant;
obtaining projected coordinates of the map-fence;
converting the projected coordinates into geographic coordinates;
obtaining a respective geographic location area contained by corresponding geo-fences based on the geographic coordinates; and
establishing the inverted index table based on the respective geographic location area contained by the corresponding geo-fences, the inverted index table including a corresponding relation between a code value corresponding to each geographic location area and geo-fences set for the corresponding geographic location area.

8. The method of claim 7, wherein the establishing the inverted index table based on the respective geographic location area includes:
combining the respective geographic location areas with another geographic location area; and
establishing the inverted index table based on the combined geographic location area.

9. The method of claim 2, wherein the pushing information relating to the map area to the client includes:
processing one or more geo-fences in the geo-fence list based on a preset condition; and
pushing corresponding information to the client based on a result of the processing.

10. The method of claim 9, wherein the preset condition is a preference set by a user or a merchant.

11. The method of claim 10, wherein the processing the one or more geo-fences in the geo-fence list based on a preset condition includes sorting the one or more geo-fences in the geo-fence list based on the preset condition.

12. The method of claim 11, wherein the pushing corresponding information to the client based on the result of the processing includes pushing information about a corresponding merchant to the client based on a result of the sorting.

13. The method of claim 10, wherein the processing the one or more geo-fences in the geo-fence list based on a preset condition includes filtering the one or more geo-fences in the geo-fence list based on the preset condition.

14. The method of claim 13, wherein the pushing corresponding information to the client based on the result of the processing includes pushing information about a corresponding merchant to the client based on a result of the filtering.

15. An apparatus comprising:
a first obtaining module that obtains a code value that represents a current geographic location area of a terminal corresponding to a client;
a second obtaining module that obtains a geo-fence list corresponding to the code value based on the code value and a pre-established inverted index table of one or more geo-fences; and
a processing module that processes the one or more geo-fences in the geo-fence list based on a preset condition, and pushing corresponding information to the client based on a result of processing.

16. The apparatus of claim 15, further comprising:
an establishing module that:
receives a map-fence set by a user or a merchant;
obtains projected coordinates of the map-fence;
converts the projected coordinates into geographic coordinates;
obtains a respective geographic location area contained by corresponding geo-fences based on the geographic coordinates; and
establishes the inverted index table based on the respective geographic location area contained by the corresponding geo-fences, the inverted index table including a corresponding relation between a code value corresponding to each geographic location area and geo-fences set for the corresponding geographic location area.

17. The apparatus claim 16, wherein the establishing module further:
combines the respective geographic location areas with another geographic location area; and
establishes the inverted index table based on the combined geographic location area.

18. The apparatus of claim 15, wherein the first obtaining module further:
receives the current geographic location area uploaded by the client and converts the received geographic location area into the code value based on a preset algorithm; or
receives the code value from the client and converted from the current geographic location area of the corresponding terminal based on a preset algorithm.

19. The apparatus of claim 15, wherein the processing module further:
sorts the one or more geo-fences in the geo-fence list based on the preset condition and pushes information about a corresponding merchant to the client based on a result of the sorting; or
filters the one or more geo-fences in the geo-fence list based on the preset condition and pushes information about a corresponding merchant to the client based on a result of the filtering.

20. One or more memories having stored thereon computer-executable instructions that are executable by one or more processors to perform operations comprising:
obtaining a code value that represents a current geographic location area of a terminal corresponding to a client;
obtaining a geo-fence list corresponding to the code value based on the code value and a pre-established inverted index table of one or more geo-fences;
processing the one or more geo-fences in the geo-fence list based on a preset condition; and
pushing corresponding information to the client based on a result of the processing.
